(19) United States
(12) Patent Application Publication
(10) Pub. No.: US 2022/0156721 A1
(43) Pub. Date: May 19, 2022

(54) METHOD TO ENSURE THE VALIDITY OF THE WAREHOUSE RECEIPT AND DEVICE FOR IT IMPLEMENTATION

(71) Applicant: OBSCHESTVO OGRANICHENNOI OTVETSTVENNOSTJU "GRAND GEKTOR", Moskva (RU)

(72) Inventors: Aleksei Alekseevich JUROV, Moskva (RU); Sergei Vladimirovich VODOLAGIN, Moskva (RU); Egor Sergeevich KRAVCHENKO, Moskva (RU); Sergei Aleksandrovich VERESCHAGIN, Moskovskaya obi., lstrinskiy r-n, (RU); Dmitry Vladimirovich TIKHONOV, Moskva (RU); Nikolai Anatolievich DEMIDOV, Moskva (RU)

(21) Appl. No.: 17/437,883

(22) PCT Filed: Sep. 19, 2019
(86) PCT No.: PCT/RU2019/000648

§ 371 Date: Sep. 10, 2021

(30) Foreign Application Priority Data
May 23, 2019 (RU) 2019115931

(51) Int. Cl. G06Q 20/36; G06Q 10/08; G06Q 20/38; G06Q 20/40; G06Q 40/02; G06Q 20/04

(52) U.S. Cl. CPC G06Q 20/3672; G06Q 10/087; G06Q 20/3825; G06Q 2220/00; G06Q 40/025; G06Q 20/3674; G06Q 20/047; G06Q 20/401

(57) ABSTRACT

An X-ray beam is generated in an interaction zone of an electron beam and a target, the zone being an annular layer of a molten fusible metal in an annular channel of a rotating anode assembly. The channel has a surface profile which prevents slopping of the molten metal in the radial direction and in both directions along the rotation axis. The liquid-metal target forms a circular cylindrical surface due to the centrifugal force acting thereupon. The linear velocity of the target is preferably higher than 80 m/s; in a vacuum chamber, a changeable membrane made of carbon nanotubes is installed in the X-ray beam path and a protective screen with apertures for electron beam entry and X-ray beam exit is arranged around the interaction zone. The technical result consists in an X-ray source with increased power, brightness, lifetime and ease of use.

The invention pertains to the computer technology, and in particular to the integrity control of data processed in automated systems.

Reference to RF Patent of Invention No. 2637486, MPK G06F21/62; G06F21/64; G06F11/30, “Control system for the integrity of continuous data recording logs”. The technical result is the necessary level of protection for data records in a file based on setting of appropriate parameters of the “one record” method: the degree of data block nesting, the number of foreign keys used. The Control system for the integrity of continuous data recording logs made in the form of an administration server containing the first input of data records, first hash code generation unit, first foreign key storage unit, second foreign key storage unit, second hash code generation unit, in addition the following units are incorporated: foreign key switching unit, internal key switching unit, k−2 foreign key storage units, m−2 hash code generation units, m−1 inputs of data records, m−1 outputs of the protected data record system, m memory concatenation units, foreign key distribution function key storage unit, internal key distribution function key storage unit.

Closest to the claimed solution is the RF patent No. 2145438, MPK G06F17/60; G06F157/00, “METHOD AND SYSTEM FOR THE EXECUTION OF CREDIT AND FINANCIAL OPERATIONS USING SECURITIES AS A DOUBLE STORAGE CERTIFICATES.” The technical result is the credit and financial process optimization. One of the systems contains the subsystems of the Credit Recipient, Credit and Financial Operations Management, Crediting, Depository, Goods Warehouse, Insurance of goods and/or property, Financial Institution, Technical Execution of Sales, Buyer, Double Storage Certificate (DSC) register maintenance. The second system contains at least one computer device, input data entry unit, input data receiving unit, potential investor database, DSC database, marketing program package, contractual document unit, contractual document issuing unit, DSC operations, DSC placement, financial operations management units, unit for sales management of DSC warehouse parts, DSC operations data output unit, subsystem for confirmation of contractual documents. The methods describe the operation of these systems.

The disadvantage of this solution is that the above system cannot fully ensure the safe issue and transfer of the warehouse receipt.

The objective of the present invention is to provide a method for ensuring the validity of warehouse receipt and a device for the implementation of method that enables users, legal entities to issue and transfer warehouse receipts to each other in electronic form in safe, ensuring the attestation of electronic digital signature and storing information about such operations in an independent blockchain system.

The task is solved due to the fact that the method to ensure the validity of warehouse receipt is that the client initiates the receipt of the warehouse receipt, the warehouse evaluates the customer's goods stored in the warehouse, the client receives the warehouse receipt and places it with the creditor as collateral for the credit. Users: warehouse, client and creditor are connected to the platform by signing the platform's user agreement in the agreement system package. Then users are able to register on the platform and enter their personal data through the platform WEB-interface. Then, on the basis of the entered data, the platform operator's server creates the warehouse's personal account, the client's personal account and the creditor's personal account in the platform's WEB interface, and assigns users unique identification data for access to the personal account. The data entered during sign up, as well as the created ID numbers, are transmitted to the user data storage unit. Then the warehouse is able to download the program via the Internet, which resulted in the WMS communication unit location on the warehouse device. After that, the client submits an offline application to the warehouse about the need to issue a warehouse receipt. Then, in automatic mode, the warehouse creates in the WMS communication unit a warehouse receipt draft reflecting all goods parameters and information previously provided by the client during registration, as well as when filling out an offline application. Further, the warehouse initiates the warehouse receipt issue: through the WMS communication unit or by transmitting information un automatic mode via the Internet to the platform operator's server to the warehouse receipt issue and storage unit. Or the warehouse creates a warehouse receipt draft, entering in manual mode all goods parameters and information previously entered by the client during registration, as well as when filling out an offline application. Then the warehouse transmits the data to the warehouse receipt issue and storage unit through the incoming user's request processing unit. The platform then starts the process of warehouse receipt issue in the warehouse receipt issue and storage unit, which consists of: assigning the warehouse receipt number to the data set entered and warehouse receipt issue date corresponding to the current date and time set on the platform operator's server. Then the warehouse receipt issue and storage unit generates a warehouse receipt draft and sends it to the warehouse personal account for signing. Then the warehouse signs the warehouse receipt draft with the warehouse EDS (Electronic Digital Signature), while at the time of warehouse receipt draft with the warehouse EDS, the platform checks the EDS through the WMS communication unit, which in turn exchanges data with the user data storage unit to confirm the compliance of this EDS to the specific warehouse. If the EDS is confirmed, a warehouse receipt is generated, and at the time of warehouse receipt generation, the platform operator's server calculates the hash function for the signed warehouse receipt in the blockchain interaction unit. Then the blockchain interaction unit generates and assigns tokens for the warehouse receipt. At the time of generation and assignment of tokens, the blockchain interaction automatically opens the client's wallet in the blockchain. Then the blockchain interaction block places the token in the client's wallet. The warehouse receipt issue and storage unit sends the signed electronic version with electronic version of digital signature through the incoming user's request processing unit to the users: client, creditor and warehouse. Then the client selects through the platform WEB-interface and through the incoming user's request processing unit from the list of available creditors to whom he intends to pledge the warehouse receipt. Then the client and the creditor sign the Offline Loan Agreement. Then the client confirms the need for this transfer and signs its by EDS in the personal account. At the time of signing the need to transfer the warehouse receipt with client's EDS the correspondence of this EDS to the specific user is verified through the user data storage unit. Then the client transfers the warehouse receipt to the creditor in the personal account through the platform WEB interface and confirms the transfer of the warehouse receipt with EDS through the incoming user's request processing unit . At the time of signing the client's digital signature the correspondence of this EDS to the specific user is checked through the user data storage unit. At the time of the warehouse receipt transfer in automatic mode, the warehouse receipt issue and storage unit receives information on the warehouse receipt transfer. At the same time, the warehouse receipt issue and storage unit makes a request to the blockchain interaction unit to transfer the receipt, upon which the blockchain interaction unit opens a creditor wallet in automatic mode. Then it transfers the token from the client's wallet to the creditor's wallet.

At this point, the blockchain interaction unit records the date and time of the transaction, and the warehouse receipt copy is sent to users by e-mail. After the repayment of loan by the client, the creditor transfers the warehouse receipt to the client in his personal account via the platform WEB interface and using the incoming user's request processing unit and the warehouse receipt issue and storage unit. The creditor selects from the list of available clients the one to whom he must return the warehouse receipt, and signs the need for this transfer with the EDS. At the time of signing the warehouse receipt with the EDS the correspondence of this EDS to the specific user is checked through the user data storage unit. After the warehouse receipt transfer to the client, the blockchain automatically carries out transactions from the creditor's wallet to the client's wallet of the warehouse receipt tokens using the blockchain interaction unit and records the date and time of the transaction in the blockchain. Then the platform sends a signed electronic version of the warehouse receipt with electronic versions of the warehouse, client and creditor digital signatures via e-mail to users. Then, to redeem the warehouse receipt, the client selects the operation of the settlement of warehouse receipt, which will be available to the client only if the warehouse receipt token is in the client's wallet, through the platform's WEB interface using the user's incoming request processing unit. Then signs the need for this operation with the EDS. Then the blockchain interaction unit creates in automatic mode a warehouse wallet and transfers the warehouse receipt token from the client's wallet to the warehouse wallet and fixes the date and time of the transaction in the blockchain. At the moment of the first token placement in the warehouse wallet, the blockchain interaction unit in automatic mode creates an archive wallet in which irrevocably places any token of the settled warehouse receipt that is in the warehouse wallet.

When the token is in the client's wallet the client sends electronic copies of the warehouse receipt and corresponding confirmation links to the blockchain by e-mail without creating the EDS in order to demonstrate the warehouse receipt to a third party.

If it is necessary to replace the pledge goods or part thereof, the client initiates offline a request for a new warehouse receipt issue, having discussed with the creditor and the warehouse the need to replace the pledge goods or part thereof. Then the warehouse in the personal account via the platform WEB-interface starts the process of issuing a new warehouse receipt in the warehouse receipt issue and storage unit. The process of new warehouse receipt issue consists of: assigning the new warehouse receipt number to the new data set entered and new warehouse receipt issue date corresponding to the current date and time set on the platform operator's server. Then the warehouse receipt issue and storage unit generates a new warehouse receipt draft and sends it to the warehouse personal account for signing. Then the warehouse signs with the EDS a new warehouse receipt draft. At the time of signing the new warehouse receipt draft with the EDS the correspondence of this EDS to the specific user is verified through the user data storage unit. If the warehouse EDS verification was successful, then immediately after that the warehouse receipts issue and storage unit sends the new warehouse receipt draft without warehouse EDS to the client and creditor personal accounts for approval. Then, if the client and the creditor agree to replace the warehouse receipt, they express their consent in their personal accounts by signing the EDS of the new warehouse receipt draft. At the time of signing the new warehouse receipt draft with client's EDS the correspondence of this EDS to the specific user is checked through the user data storage unit. If all the necessary EDS of users have been delivered and confirmed, a new warehouse receipt is generated in the warehouse receipt issue and storage unit. At the time of new warehouse receipt generation, the platform operator's server calculates the hash function for the new warehouse receipt in the blockchain interaction unit. Then the blockchain interaction unit generates and assigns tokens for the new warehouse receipt and moves them to the place of tokens of the old warehouse receipt with simultaneous replacement of the old warehouse receipt tokens.

A device for implementing the method of ensuring the validity of warehouse receipt consists of a blockchain with a storage unit containing user wallets: warehouse wallet, client wallet and creditor wallet; as well as a platform, which contains: agreement system package, warehouse device containing the WMS communication unit, and platform operator's server, which contains: platform web-interface with user personal accounts: warehouse personal account, client personal account, creditor personal account; user data storage unit, user incoming request processing unit, warehouse receipt issue and storage unit, blockchain interaction unit. The agreement system package is connected by two-way communication with users: warehouse, client and creditor. The warehouse's personal account has two-way communication with the warehouse, user data storage unit and user incoming request processing unit. The client's personal account has two-way communication with the client, user data storage unit and user incoming request processing unit. The creditor's personal account has two-way communication with the creditor, user data storage unit and user incoming request processing unit. The user incoming request processing unit in turn is connected by two-way communication with the warehouse receipt issue and storage unit. The user data storage unit has two-way communication with the user incoming request processing unit. The warehouse receipt issue and storage unit has two-way communication with the blockchain interaction unit and WMS communication unit. The WMS modulated communication unit has two-way communication with the user data storage unit. A communication device comprising the WMS modulated communication unit is connected by two-way communication with the WMS unit of warehouse system located on the warehouse server, which in turn is connected by a two-way communication with the warehouse. The warehouse has two-way communication with the client. The client has two-way communication with the creditor and one-way communication with a third party. The third party has a two-way communication with the blockchain. Blockchain is connected by two-way communication with the blockchain interaction unit. The blockchain interaction unit is in turn connected by two-way communication with the warehouse wallet, client's wallet and creditor's wallet.

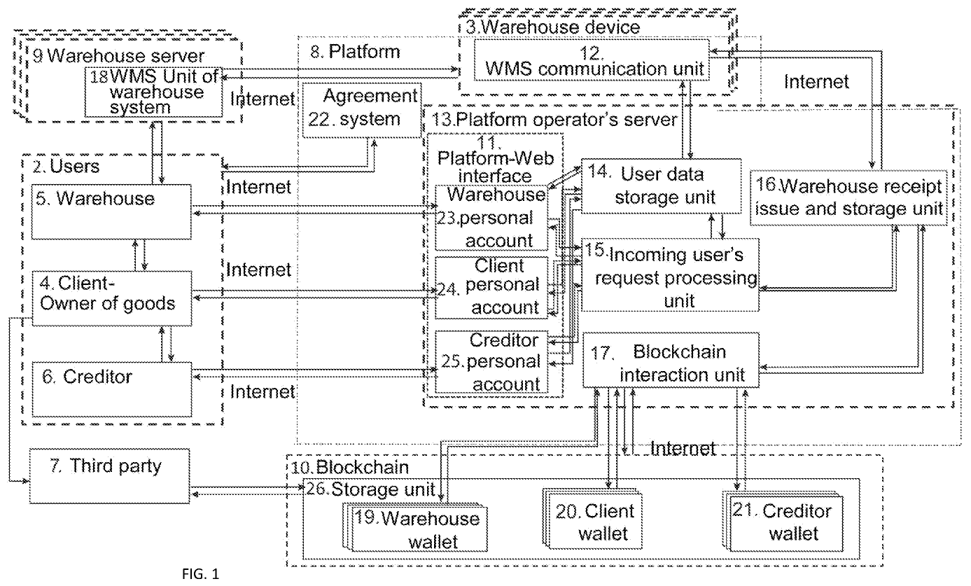

FIG. 1 shows the Operation Scheme of the warehouse receipt validation device.

A method to ensure the validity of warehouse receipt, which is a legally valid document that confirms the availability of a particular commodity in the specified warehouse 5, as well as confirms that the rights to the goods belong to a specific legal entity-owner of goods. The warehouse receipt is issued by the platform 8 functional in electronic form. The method is that the client 4 initiates the acquisition of warehouse receipt, the warehouse evaluates the goods of client 4 stored in warehouse 5, the client 4 receives a warehouse receipt and places it with creditor 6 on pledge. Users: warehouse 5, which is a legal entity that provides safe custody services, acts as a custodian under the Agreement between the owner of goods—client 4 and warehouse 5, which issues warehouse receipts; client 4, which is a legal entity acting as a depositor (owner of goods) under the Agreement between client 4 and warehouse 5, the borrower under the Agreement between client 4 and creditor 6 and the payer under the Agreement on the offer of platform services; and creditor 6, which is a legal entity acting as a borrower under the Agreement with client 4 and granting a loan (credit) against pledged warehouse receipts, are connected to platform 8, which is a technological device consisting of different units that speeds up and secures the process of issue and circulation of warehouse receipts, by signing platform user agreements in the agreement system package 22, which is a set of related legal and technical documents, including rules of platform 8, bilateral agreements between the operator of platform 8 and client 4, warehouse 5, creditor 6, technical conditions of platform 8. Than users 2 are permitted to sign up in platform 8 and through the WEB-interface of platform 11, containing the functional of user accounts, that includes signing up, issue of warehouse receipts, view of reports, and is also part of the interface of blockchain interaction unit 17, user data storage unit 14 and used to interact with them, users 2 enter their personal data. Then the platform operator's server 13, which contains the web interface of platform 11 with personal user accounts: personal warehouse account 23, personal client account 24, personal creditor account 25; the user data storage unit 14, incoming user's request processing unit 15, warehouse receipt issue and storage unit 16, blockchain interaction unit 17, on the basis of the entered data creates the personal account of warehouse 23, personal account of client 24 and personal account of creditor 25 and assigns users unique identification data for access to the created personal account in the WEB interface of platform 11. The data entered during signing up, as well as the generated identification numbers, are transferred to the user data storage unit 14, which registers and stores all login details of users 2 and transfers them to the incoming request processing unit 15 for later use. Then the warehouse 5 gets the opportunity to download the program via the Internet, and after that the WMS communication unit 12 is placed on the warehouse device 3, which is a computer or a mobile device of warehouse employee 5, authorized to work with warehouse receipts on behalf of the warehouse 5, which is a software package that provides connection to platform 8 and management of applications for issue of warehouse receipts, as well as providing data on the current status of issued warehouse receipts. Then the client submits an application offline to the warehouse 5 on the need to issue a warehouse receipt. Then, in automatic mode, the warehouse 5 creates in the WMS communication unit 12 a warehouse receipt draft reflecting all product parameters and information previously provided by the client 4 during registration, as well as when filling out an offline application. Further, warehouse 5 initiates the warehouse receipt issue through the WMS communication unit 12 or by transmitting information un automatic mode via the Internet to the platform operator's server 13 to the warehouse receipt issue and storage unit 16, which ensures the issue and stores data on all operations with the warehouse receipt. Or the warehouse creates a warehouse 23 receipt draft, entering in manual mode all product parameters and information previously entered by client 4 during registration, as well as when filling out an offline application. Warehouse 5 transfers this data to the warehouse receipt issue and storage unit 16 through the incoming request processing unit 15, which provides information in personal accounts of users on the issued warehouse receipts and their status. Then the platform 8 starts issuing a warehouse receipt in the warehouse receipt issue and storage unit 16. First, the warehouse receipt numbers are assigned to the set of entered data and warehouse receipt issue date corresponding to the current date and time set on platform operator's server 13. Then the warehouse receipt issue and storage unit 16 generates a warehouse receipt draft and sends it to the warehouse personal account 23 for signing. Then the warehouse 5 signs with the warehouse EDS the warehouse receipt draft. At the time of signing the warehouse receipt draft with the warehouse EDS 5, the platform 8 checks the EDS through the WMS communication unit 12, which in turn exchanges data with the user data storage unit 14 to confirm the compliance of this EDS to the specific warehouse. If the EDS is confirmed the warehouse receipt is generated. At the time of the warehouse receipt generation, the platform operator's server 13 calculates the hash function for the signed warehouse receipt in the blockchain interaction unit 17, which provides cryptography and transfer of the warehouse receipt data to the blockchain system 10, which is a distributed data system in which encrypted warehouse receipts are stored, as well as all data on operations with them in the wallet section of each user 2. Then blockchain interaction unit 17 generates and assigns tokens for the warehouse receipt. At the time of generation and assignment of tokens, the blockchain interaction unit 17 automatically generates the client's wallet 20 in the blockchain 10, which is the unique account of client 4. Then the blockchain interaction block 17 places the token in the client's wallet 20. The warehouse receipt issue and storage unit 16 sends the signed electronic version with electronic version of digital signature through the incoming user's request processing unit 15 to the users 2 by e-mail: client 4, creditor 6 and warehouse 5. Then the client 4 selects through the platform WEB-interface 11 and through the incoming user's request processing unit 15 from the list of available creditors 6 to whom he intends to pledge the warehouse receipt. Then the client 4 and the creditor 6 sign the Offline Loan Agreement. Then client 4 confirms the need for this transfer and signs its with EDS in the personal account 24, while at the time of signing the need for this EDS transfer of client 4, this EDS correspondence to a specific user is verified by the user data storage unit 14. Then the client 4 transfers the warehouse receipt to the creditor 6 in the personal account 24 through the platform WEB interface 11 and confirms the transfer of the warehouse receipt with EDS through the incoming user's request processing unit 15 and user data storage unit 14. At the time of signing the client's 4 EDS the correspondence of this EDS to the specific user is verified through the user data storage unit 14. At the time of the warehouse receipt transfer in automatic mode, the warehouse receipt issue and storage unit 16 receives information on the warehouse receipt transfer. Concurrently the warehouse receipt issue and storage unit 16 sends a request to the blockchain interaction unit 17 for the transfer of receipt. Then the blockchain interaction unit 17 in automatic mode generates the creditor's wallet 21 in blockchain 10, which is the unique account of the creditor 6. Then it transfers the token from the client's wallet 20 to the creditor's wallet 21. At this point, the blockchain interaction unit 17 records the date and time of the transaction. At the same time, a copy of the warehouse receipt is sent by email to users 2. After the repayment of loan by the client 4, the creditor transfers the warehouse receipt to the client 4 in his personal account via the platform WEB interface 11 and using the incoming user's request processing unit 15 and the warehouse receipt issue and storage unit 16. The creditor 6 selects from the list of available clients 4 the one to whom he must return the warehouse receipt, and signs the need for this transfer with the EDS. At the time of signing the warehouse receipt with the EDS the correspondence of this EDS to the specific user is verified through the user data storage unit 14. After the warehouse receipt transfer to the client 4, the blockchain 10 automatically carries out transactions from the creditor's wallet 21 to the client's wallet 20 of the warehouse receipt tokens using the blockchain interaction unit 17 and records the date and time of the transaction in the blockchain 10. Then the platform 8 sends a signed electronic version of the warehouse receipt with electronic versions of the warehouse 5, client 4 and creditor 6 digital signatures via e-mail to users. Then, to redeem the warehouse receipt, in the personal account 24 the client 4 selects the operation of the settlement of warehouse receipt, which will be available to the client 4 only if the warehouse receipt token is in the client's wallet 20, through the platform's WEB interface 11 using the user's incoming request processing unit 15 and signs the need for this operation with the EDS. Then the blockchain interaction unit 17 creates in automatic mode a warehouse wallet 19, which is a unique warehouse account 5, and transfers the warehouse receipt token from the client's wallet 20 to the warehouse wallet 19 and records the date and time of the transaction in the blockchain 10. At the moment of the first token placement in the warehouse wallet 19, the blockchain interaction unit 17 in automatic mode creates an archive wallet in which irrevocably places any token of the settled warehouse receipt that is in the warehouse wallet 19. When the token is in the client's wallet 20 the client 4 sends electronic copies of the warehouse receipt and corresponding confirmation links to the blockchain by e-mail without creating the EDS in order to demonstrate the warehouse receipt to a third party, which is a legal entity interested in the transaction with client 4, and not a platform 8 user.

If it is necessary to replace the pledge goods or part thereof, the client 4 initiates offline a request for a new warehouse receipt issue, having discussed with the creditor 6 and the warehouse 5 the need to replace the pledge goods or part thereof. Then the warehouse 5 in the personal account via the platform WEB-interface 11 starts the process of issuing a new warehouse receipt on the platform 8 in the warehouse receipt issue and storage unit 16. First, the new warehouse receipt numbers are assigned to the new set of entered data and new warehouse receipt issue date corresponding to the current date and time set on platform operator's server 13. Then warehouse receipt issue and storage unit 16 generates a new warehouse receipt draft and sends it to the warehouse personal account 23 for signing. Then the warehouse 5 signs with the EDS a new warehouse receipt draft. At the time of signing the new warehouse receipt draft with the warehouse5 EDS the correspondence of this EDS to the specific user is verified through the user data storage unit 14. If the warehouse EDS verification was successful, then immediately after that the warehouse receipts issue and storage unit 16 sends the new warehouse receipt draft without warehouse EDS to the client 24 and creditor 25 personal accounts for approval. Then, if the client 4 and the creditor 6 agree to replace the warehouse receipt, they express their consent in their personal accounts 24 and 25 by signing the EDS of the new warehouse receipt draft. At the time of signing the new warehouse receipt draft with client's 4 and creditor's 6 EDS the correspondence of these EDS to the specific users is verified through the user data storage unit 14. if all the necessary EDS of users are delivered and confirmed, a new warehouse receipt is generated in the warehouse receipt issue and storage unit 16, and at the time of the new warehouse receipt generation, the platform operator's server 13 calculates the hash function for the new warehouse receipt in the blockchain interaction unit 17. Then the blockchain interaction unit 17 generates and assigns tokens for the new warehouse receipt and moves them to the place of tokens of the old warehouse receipt with simultaneous replacement of the old warehouse receipt tokens.

The claimed device for ensuring the validity of warehouse receipt consists of the blockchain 10 with the storage unit containing user wallets: warehouse wallet 19, client wallet 20 and creditor wallet 21. Together with platform 8, which contains: agreement system package 22, warehouse device 3, including WMS communication unit 12, and platform operator's server, which contains: Platform WEB interface 11 with personal user accounts: personal warehouse account 23, personal client account 25, personal creditor account 25; user data storage unit 14, user incoming request processing unit 15, warehouse receipt issue and storage unit 16, blockchain interaction unit 17.

The agreement system package 22 is connected by two-way communication with users 2: warehouse 5, client 4 and creditor 6. The warehouse's personal account 23 has two-way communication with the warehouse 5, user data storage unit 14 and user incoming request processing unit 15. The client's personal account 24 has two-way communication with the client 4, user data storage unit 14 and user incoming request processing unit 15. The creditor's personal account 25 has two-way communication with the creditor 6, user data storage unit 14 and user incoming request processing unit 15. The user incoming request processing unit 15 in turn is connected by two-way communication with the warehouse receipt issue and storage unit 16. The user data storage unit 14 has two-way communication with the user incoming request processing unit 15. The warehouse receipt issue and storage unit 16 has two-way communication with the blockchain interaction unit 17 and WMS communication unit 12. The WMS communication unit has two-way communication with the user data storage unit 14. A communication device comprising the WMS communication unit is connected by two-way communication with the WMS unit of warehouse system located on the warehouse server 9, which in turn is connected by a two-way communication with the warehouse 5. The warehouse 5 has two-way communication with the client 4. The client 4 has two-way communication with the creditor 6 and one-way communication with a third party 7. The third party has a two-way communication with the blockchain. The blockchain is connected by two-way communication with the blockchain interaction unit 17. The blockchain interaction unit 17 is in turn connected by two-way communication with the warehouse wallet 19, client's wallet 20 and creditor's wallet 21.

All of the above confirms the implementation of the set task, namely: provide a method for ensuring the validity of warehouse receipt and a device for the implementation of method that enables users, legal entities to issue and transfer warehouse receipts to each other in electronic form in safe, ensuring the attestation of electronic digital signature and storing information about such operations in an independent blockchain system.

List of Abbreviations

EDS—electronic digital signature

The following items are additionally assigned for correct description of the device operation:

List of Positions:

1. Users

2. Warehouse device

3. Client (owner of goods)

4. Warehouse

5. Creditor

6. Third party

7. Platform

8. Warehouse server

9. Blockchain

10. Platform web interface

11. WMS communication unit

12. Platform operator's server

13. User data storage unit

14. Incoming user's request processing unit

15. Warehouse receipt issue and storage unit

16. Blockchain interaction unit

17. WMS unit of warehouse system

18. Warehouse wallet

19. Client wallet

20. Creditor wallet

21. Agreement system package

22. Warehouse personal account

23. Client personal account

24. Creditor personal account

25. Storage unit in blockchain.

What is claimed is:

1. A method to ensure a validity of a warehouse receipt is that a client initiates an acquisition of the warehouse receipt, a warehouse evaluates customer's goods stored in the warehouse, the client receives the warehouse receipt and places it with a creditor as a collateral for a credit,
characterized in that
users; the warehouse, the client and the creditor are connected to a platform by signing platform's user agreements in an agreement system unit, after which users are able to sign up on the platform and users enter their personal data through a platform's WEB interface, then a platform operator's server creates in the platform's WEB-interface a personal account of the warehouse, a personal account of the client and a personal account of the creditor and assigns users unique identification data for access in the generated personal account, while the data entered during signing up, as well as generated identification numbers, are transferred to a user data storage unit, after that the warehouse is able to download a program via the Internet, as a result a WMS communication unit is placed on a warehouse device, after that the client submits an offline application to the warehouse on a need to issue a warehouse receipt, then in automatic mode the warehouse generates a warehouse receipt draft in the WMS communication unit reflecting all parameters of goods and an information previously provided by the client during signing up, as well as during a preparation of the offline application, then the warehouse initiates an issue of the warehouse receipt; through the WMS communication unit or by transmitting information in automatic mode via the Internet to the a operator's server to a warehouse receipt issue and storage unit; or the warehouse creates the warehouse receipt draft, entering in a manual mode all goods parameters and the information previously entered by the client during registration, as well as when filling out the offline application, then the warehouse sends this data through an incoming user's request processing unit to the warehouse receipt issue and storage unit; then the platform starts issuing the warehouse receipt in the warehouse receipt issue and storage unit consisting of: assigning a number of the warehouse receipt to a set of entered data and a warehouse receipt issue date corresponding to a current date and a time set on the platform operator's server, then the warehouse receipt issue and storage unit generates the warehouse receipt draft and sends it to the warehouse personal account for signing, then the warehouse signs the warehouse receipt draft with the warehouse EDS, and at the time of signing the warehouse receipt with a warehouse EDS, the platform verifies the EDS through the WMS communication unit, which in turn exchanges data with the user data storage unit to confirm a correspondence of this EDS to the specific warehouse, and if the electronic digital signature is confirmed, the warehouse receipt is generated, and if the EDS is confirmed the warehouse receipt is generated and the platform operator's server calculates a hash function for the signed warehouse receipt in a blockchain interaction unit, then the blockchain interaction unit generates and assigns tokens for the warehouse receipt, and at a time of generation and assignment of tokens the blockchain interaction unit automatically creates a client's wallet in a blockchain, after which the blockchain interaction unit places the token in the client's wallet; the warehouse receipt issue and storage unit sends a signed electronic version with an electronic version of the digital signature through the incoming user's request processing unit to the users: the client, the creditor and the warehouse; then the client selects through the platform WEB-interface and incoming user's request processing unit from a list of available creditors the one to whom he intends to transfer the warehouse receipt as security, after which the client and the creditor sign an offline loan agreement, then the client confirms a need for this transfer and signs the transfer with the EDS in the personal account, while at a time of signing the need for this EDS transfer, the client verifies a correspondence of this EDS to a specific user by the user data storage unit, after which the client transfers the warehouse receipt to the creditor in the personal account via the platform WEB interface and confirms the transfer of the warehouse receipt of the EDS through the incoming user's request processing unit and the user data storage unit, while at a time of client EDS signing the correspondence of this EDS to the specific user is verified through the user data storage unit, and at a time of the warehouse receipt transfer in automatic mode the warehouse receipt issue and storage unit receives an information about the transfer of the warehouse receipt, at the same time, the warehouse receipt issue and storage unit makes a request to the blockchain interaction unit for the transfer of receipt, after which the blockchain interaction unit automatically creates a creditor wallet in the blockchain, and then transfers the token from the client's wallet in the creditor's wallet, at this moment, the blockchain interaction unit records a date and a time of the transaction, and a warehouse receipt copy is sent to users by e-mail; after the client repays the loan, the creditor transfers the warehouse receipt to the client in his personal account via the platform's WEB interface and through the incoming user's request processing unit and the warehouse receipt issue and storage unit, and the creditor selects from a list of available clients the one to whom he should return the warehouse receipt, and signs the EDS need for this transfer, and at a time of signing the warehouse receipt EDS the user data storage unit verifies a correspondence of this EDS to a specific user, and after the transfer of the warehouse receipt to the client, the blockchain automatically transfers the warehouse receipt tokens from the creditor's wallet to the client's wallet through the blockchain interaction unit and records a the date and a time of the transaction in the blockchain, then the platform sends a signed electronic version of the warehouse receipt with electronic versions of digital warehouse, the client and the creditor signatures by e-mail to the users, then in order to redeem the warehouse receipt the client selects an operation of a settlement of the warehouse receipt, which will be available to the client only if the warehouse receipt token is in the client's wallet, through the platform's WEB interface using the user's incoming request processing unit , which will be available to the client only if there is the warehouse receipt token in the client's wallet, and signs a need for this digital signature, then the blockchain interaction unit creates in an automatic mode a warehouse wallet and transfers the warehouse receipt token from the client's wallet to the warehouse wallet and records a date and a time of the transaction in the blockchain; at the moment of a first token placement in the warehouse wallet, the blockchain interaction unit in automatic mode creates an archive wallet in which irrevocably places any token of the settled warehouse receipt that is in the warehouse wallet; when the token is in the client's wallet the client sends electronic copies of the warehouse receipt and corresponding confirmation links to the blockchain by e-mail without creating the EDS in order to demonstrate the warehouse receipt to a third party.

2. The method to ensure the validity of warehouse receipt as per claim 1, wherein if it is necessary to replace pledge goods or a part thereof, the client initiates offline a request for a new warehouse receipt issue, having discussed with the creditor and the warehouse a the need to replace the pledge goods or the part thereof, then the warehouse in the personal account via the platform WEB-interface starts a process of issuing the new warehouse receipt in the warehouse receipt issue and storage unit consisting of: assigning a new warehouse receipt number to a new data set entered and a new warehouse receipt issue date corresponding to a current date and a time set on the platform operator's server, then the warehouse receipt issue and storage unit generates a new warehouse receipt draft and sends it to the warehouse personal account for signing, at a time of signing the new warehouse receipt draft with the EDS a correspondence of this EDS to the specific user is verified through the user data storage unit, if the warehouse EDS verification was successful, then immediately after that the warehouse receipts issue and storage unit sends the new warehouse receipt draft without warehouse EDS to the client and the creditor personal accounts for approval, then, if the client and the creditor agree to replace the warehouse receipt, they express their consent in their personal accounts by signing the EDS of the new warehouse receipt draft, at a time of signing the new warehouse receipt draft with client's EDS a correspondence of this EDS to the specific user is verified through the user data storage unit, if all the necessary EDS of users have been delivered and confirmed, the new warehouse receipt is generated in the warehouse receipt issue and storage unit, at a the time of new warehouse receipt generation, the platform operator's server calculates a hash function for the new warehouse receipt in the blockchain interaction unit, then the blockchain interaction unit generates and assigns tokens for the new warehouse receipt and moves them to the place of tokens of the old warehouse receipt with simultaneous replacement of the old warehouse receipt tokens.

3. A device for implementing a method of ensuring a validity of a warehouse receipt as per claim 1 consisting of a blockchain with a storage unit containing user wallets: a warehouse wallet, a client wallet and a creditor wallet; as well as a platform, which contains: a contract system unit, a warehouse device containing a WMS communication unit, and a platform operator server, which contains: a platform web-interface with user personal accounts: a warehouse personal account, a client personal account, a creditor personal account; a user data storage unit, a user incoming request processing unit, a warehouse receipt issue and storage unit, a blockchain interaction unit;
an agreement system package is connected by two-way communication with users: a warehouse, a client and a creditor; the warehouse's personal account has two-way communication with the warehouse, user data storage unit and the user incoming request processing unit, the client's personal account has two-way communication with the client, the user data storage unit and the user incoming request processing unit and the creditor's personal account has two-way communication with the creditor, the user data storage unit and the user incoming request processing unit and the user incoming request processing unit in turn is connected by two-way communication with the warehouse receipt issue and storage unit and the user data storage unit has two-way communication with the user incoming request processing unit and the warehouse receipt issue and storage unit has two-way communication with the blockchain interaction unit and a WMS communication unit and a WMS modulated communication unit has two-way communication with the user data storage unit and the communication device comprising the WMS modulated communication unit is connected by two-way communication with a WMS unit of warehouse system located on a warehouse server, which in turn is connected by a two-way communication with the warehouse and the warehouse has two-way communication with the client and the client has two-way communication with the creditor and one-way communication with a third party and the third party has a two-way communication with the blockchain while the blockchain is connected by, two-way communication with the blockchain interaction unit and the blockchain interaction unit is in turn connected by two-way communication with the warehouse wallet, the client's wallet and the creditor's wallet.
